(19) United States
(12) Patent Application Publication
(10) Pub. No.: US 2024/0280952 A1
(43) Pub. Date: Aug. 22, 2024

(54) AUTOMATIC AND ITERATIVE CONFIGURATION OF BUILDING DEVICE RELATIONSHIPS

(71) Applicant: Tyco Fire & Security GmbH, Neuhausen am Rheinfall (CH)

(72) Inventors: Abhishek Uday Khardenavis, Pune (IN); Louis Loizides, Safety Harbor, FL (US); Gregory A. Makowski, Los Altos, CA (US); Risavsingh Virendrakumar Saingar, Pune (IN)

(21) Appl. No.: 18/582,476

(22) Filed: Feb. 20, 2024

(30) Foreign Application Priority Data
Feb. 21, 2023 (IN) 202321011595

(51) Int. Cl. G05B 19/042

(52) U.S. Cl. CPC G05B 19/042; G05B 2219/25011

(57) ABSTRACT

1. Systems and methods for automatically configuring source-load relationships in building systems are disclosed. A system can identify a first control device of a plurality of control devices of a building. The first control device can control at least one physical parameter of a space of the building. The system can identify a first building device of a plurality of building devices of the building. The first building device can measure the at least one physical parameter within the building. The system can determine that a relationship between the first control device and the first building device is undefined, and generate the relationship between the first control device and the first building device based on one or more correlations determined based on data provided by the plurality of control devices and sensor data captured by the plurality of building devices.

### CROSS-REFERENCE TO RELATED APPLICATIONS

This application claims the benefit of and priority to Indian Provisional Patent Application No. 20/232,1011595, filed Feb. 21, 2023, the contents of which is incorporated by reference herein in its entirety for all purposes.

### BACKGROUND

The present disclosure relates generally to building management systems (BMSs) and, more specifically, to automatically determining correlations between building devices and control devices within a building based on information collected from said devices. However, manually defining relationships between systems within a building, such as which air handling units (AHUs) serve which variable air volume (VAV) devices, is both tedious and error prone.

### SUMMARY

At least one aspect of the present disclosure is directed to a method of automatically defining control relationships between building systems. The method can be performed, for example, by one or more processors coupled to memory. The method can include identifying a plurality of control devices and a plurality of plurality of building devices of a building. The method can include activating the plurality of control devices using a plurality of test signals to generate a set of sensor data via the building devices. The method can include determining one or more correlations between the plurality of control devices and the plurality of building devices using the set of sensor data. The one or more correlations include a variance inflation factor or a cross correlation. The method can include storing the one or more correlations for use in at least one of configuring the plurality of building devices or controlling the plurality of control devices.

In some implementations, the plurality of test signals activates the plurality of control devices according to at least one of a schedule or a pattern. In some implementations, the method includes determining a time shift for the cross correlation based on the set of sensor data. In some implementations, determining the one or more correlations is further based on data provided by the plurality of control devices. In some implementations, activating the plurality of control devices comprises activating a first control device of the plurality of control devices for a first predetermined time period and de-activating a second control device of the plurality of control devices for the first predetermined time period. In some implementations, activating the plurality of control devices comprises activating the second control device of the plurality of control devices for a second predetermined time period and de-activating the first control device of the plurality of control devices for the second predetermined time period.

In some implementations, the plurality of control devices comprises an air handler unit and the plurality of building devices comprises a variable air volume device. In some implementations, determining the one or more correlations comprises determining a confidence score indicating a strength of a relationship between a first control device of the plurality of control devices and a first building device of the plurality of building devices. In some implementations, the method can include generating a set of virtual sensor data for a first building device of the plurality of building devices based on the one or more correlations and sensor data received from a second building device of the plurality of building devices.

In some implementations, the method can include detecting a deviation from an expected value in the set of virtual sensor data. In some implementations, the method can include comparing the one or more correlations to a set of expected correlations of a building schema. In some implementations, the plurality of test signals are selected based on a fault detected in the building. In some implementations, the method can include generating the plurality of test signals based on a fault detected in the building. In some implementations, the method can include generating a graphical user interface that provides a visualization of at least a portion of the one or more correlations.

In some implementations, the graphical user interface further provides a second visualization of at least a portion of a set of expected correlations of a building schema. In some implementations, the method can include detecting a fault in a building device of the plurality of building devices or a control device of the plurality of control devices based on the one or more correlations.

At least one other aspect of the present disclosure is directed to a system for automatically defining control relationships between building systems. The system can include one or more processors coupled to memory. The system can identify a plurality of control devices and a plurality of plurality of building devices of a building. The system can activate the plurality of control devices using a plurality of test signals to generate a set of sensor data via the building devices. The system can determine one or more correlations between the plurality of control devices and the plurality of building devices using the set of sensor data. The one or more correlations include a variance inflation factor or a cross correlation. The system can store the one or more correlations for use in at least one of configuring the plurality of building devices or controlling the plurality of control devices.

In some implementations, the plurality of test signals activates the plurality of control devices according to at least one of a schedule or a pattern. In some implementations, the system can determine a time shift for the cross correlation based on the set of sensor data. In some implementations, the system can determine the one or more correlations further based on data provided by the plurality of control devices.

At least one other aspect of the present disclosure is directed to a non-transitory computer-readable medium with processor-executable instructions embodied thereon that, when executed by one or more processors, cause the one or more processors to perform operations. The operations can include identifying a plurality of control devices and a plurality of plurality of building devices of a building. The operations can include activating the plurality of control devices using a plurality of test signals to generate a set of sensor data via the building devices. The operations can include determining one or more correlations between the plurality of control devices and the plurality of building devices using the set of sensor data. The one or more correlations include a variance inflation factor or a cross correlation. The operations can include storing the one or more correlations for use in configuring the plurality of building devices or controlling the plurality of control devices.

At least one other aspect of the present disclosure is directed to a method of automatically configuring source-load relationships in building systems. The method can be performed, for example, by one or more processors coupled to memory. The method can include identifying a first control device of a plurality of control devices of a building, the first control device configured to control at least one physical parameter of a space of the building. The method can include identifying a first building device of a plurality of building devices of the building, the first building device configured to measure the at least one physical parameter within the building. The method can include determining that a relationship between the first control device and the first building device is undefined. The method can include, responsive to determining that the relationship between the first control device and the first building device is undefined, generating the relationship between the first control device and the first building device based on one or more correlations determined based on data provided by the plurality of control devices and sensor data captured by the plurality of building devices. The one or more correlations include a variance inflation factor or a cross correlation.

In some implementations, the method includes determining a time shift for the cross correlation based on the data provided by the plurality of control devices and the sensor data. In some implementations, the method can include determining the one or more correlations by iteratively activating or de-activating the first control device or the first building device. In some implementations, generating the relationship comprises determining that a relationship confidence value calculated based on the one or more correlations satisfies a predetermined threshold. In some implementations, the one or more correlations indicate that the first control device controls at least a portion of the at least one physical parameter of the space of the building that is measured by the first building device.

In some implementations, the first control device is an air-handling unit and the first building device is a variable air volume device. In some implementations, the method can include determining that a second relationship between the first control device of the plurality of control devices and a second building device of the plurality of building devices is undefined. In some implementations, the method can include, responsive to determining that the relationship between the first control device and the second building device is undefined, generating a relationship confidence value that indicates a likelihood that the first control device controls in part a parameter of the building that is measured by the second building device.

In some implementations, the method can include generating an indication that the second building device and the first control device are unrelated responsive to the relationship confidence value being less than a confidence threshold. In some implementations, the method can include generating the second relationship between the second building device and the first control device responsive to the relationship confidence value being satisfying a confidence threshold.

At least one other aspect of the present disclosure is directed to a system for automatically configuring source-load relationships in building systems. The system can include one or more processors coupled to memory. The system can identify a first control device of a plurality of control devices of a building, the first control device configured to control at least one physical parameter of a space of the building. The system can identify a first building device of a plurality of building devices of the building, the first building device configured to measure the at least one physical parameter within the building. The system can determine that a relationship between the first control device and the first building device is undefined. The system can, responsive to determining that the relationship between the first control device and the first building device is undefined, generate the relationship between the first control device and the first building device based on one or more correlations determined based on data provided by the plurality of control devices and sensor data captured by the plurality of building devices. The one or more correlations include a variance inflation factor or a cross correlation.

In some implementations, the system can determine a time shift for the cross correlation based on the data provided by the plurality of control devices and the sensor data. In some implementations, the system can determine the one or more correlations by iteratively activating or de-activating the first control device or the first building device. In some implementations, the system can generate the relationship by performing operations comprising determining that a relationship confidence value calculated based on the one or more correlations satisfies a predetermined threshold.

In some implementations, the one or more correlations indicate that the first control device controls at least a portion of the at least one physical parameter of the space of the building that is measured by the first building device. In some implementations, the first control device is an air-handling unit and the first building device is a variable air volume device. In some implementations, the system can determine that a second relationship between the first control device of the plurality of control devices and a second building device of the plurality of building devices is undefined. In some implementations, the system can, responsive to determining that the relationship between the first control device and the second building device is undefined, generate a relationship confidence value that indicates a likelihood that the first control device controls in part a parameter of the building that is measured by the second building device.

In some implementations, the system can generate an indication that the second building device and the first control device are unrelated responsive to the relationship confidence value being less than a confidence threshold. In some implementations, the system can generate the second relationship between the second building device and the first control device responsive to the relationship confidence value being satisfying a confidence threshold.

Yet another aspect of the present disclosure is directed to a non-transitory computer-readable medium with processor-executable instructions embodied thereon that, when executed by one or more processors, cause the one or more processors to perform operations. The operations can include identifying a first control device of a plurality of control devices of a building, the first control device configured to control at least one physical parameter of a space of the building. The operations can include identifying a first building device of a plurality of building devices of the building, the first building device configured to measure the at least one physical parameter within the building. The operations can include determining that a relationship between the first control device and the first building device is undefined. The operations can include, responsive to determining that the relationship between the first control device and the first building device is undefined, generating the relationship between the first control device and the first building device based on one or more correlations determined based on data provided by the plurality of control devices and sensor data captured by the plurality of building devices. The one or more correlations include a variance inflation factor or a cross correlation.

In some implementations, the operations can include determining a time shift for the cross correlation based on the data provided by the plurality of control devices and the sensor data.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of “a,” “an,” and “the” include plural referents unless the context clearly dictates otherwise.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a block diagram of a building management system (BMS) that may be used to monitor and/or control the building of FIG. 1, according to some embodiments.

FIG. 5 is a block diagram of a system for automatically generating relationships in building systems, according to some embodiments.

FIG. 6 is a flow chart of an example process for automatically defining control relationships between building systems, according to some embodiments.

FIG. 7 is a flow chart of an example process for automatically configuring source-load relationships in building systems, according to some embodiments.

FIG. 8 depicts a graph of time-series data that indicates relationships between an AHU and several VAVs, according to some embodiments.

FIG. 9 depicts another graph of time-series data that indicates both correct and incorrect relationships between an AHU and several VAVs, according to some embodiments.

### DETAILED DESCRIPTION

Although relationships between building assets (e.g., heating, ventilation, and air conditioning) may be defined manually, doing so without a comprehensive schema of a building is time consuming, difficult, and error prone. Certain source-load relationships (e.g., between air-handling units and variable air volume devices, other source-load devices, etc.) are not always defined in a control system. For example, the source-load logic may be able to operate (albeit inefficiently) without knowledge of which AHUs affect which VAVs, for example. However, this results in system-wide inefficiencies because source devices, such as AHUs, typically end up supplying more air than necessary.

Opportunities for building-specific optimizations are missed without knowledge of the relationships between source and load devices within the building. For example, when full source-load relationships are known, better control of air pressure and temperature can be achieved within a building at a system level, optimized building-wide activation schedules for different devices can be created, and optimal start-stop times or conditions can be defined within the control logic to optimize for target metrics such as energy efficiency. However, for the aforementioned reasons, defining these relationships is generally impracticable without significant manual effort, and may still be error prone.

The systems and methods described herein provide techniques for auto-perturbation of different building devices (e.g., AHUs, VAVs, other source-load devices, etc.) to automatically define and configure control relationships between building systems. To do so, the systems and methods described herein can automatically activate (e.g., perform auto-perturbation) of different source devices (e.g., AHUs, water systems, etc.) and monitor corresponding variables (e.g., air temperature, air pressure, water temperature, water pressure, etc.) of downstream load devices (e.g., VAVs, etc.). The systems and methods described herein can determine correlations by determining the covariance between data from source and load devices, and generate a confidence score indicating a strength in the relationship between each set of devices.

These techniques can be extended to covariance of different building parameters or relationships in different seasons, conditions, or circumstances. Additionally, the systems and methods described herein can be utilized to detect or diagnose abnormalities in building systems or deviations from expected behavior. Data gaps (e.g., missing sensor data when sensors go offline) can be estimated based on the relationships between source systems and different load systems. For example, based on the automatic correlation techniques described herein, a first sensor and a second sensor may be determined to respond similarly (e.g., proportionally by some determined factor) to a particular source. If the first sensor goes offline, the relationship with the second sensor can be utilized (e.g., the proportional factor) to generate virtual data points (e.g., estimated sensor data) based on the readings from the second sensor. The techniques described herein may be performed by a server local to a building, by one or more servers that manage one or more buildings, or by a cloud computing system remote from one or more buildings. Various information relating to the techniques described herein can be visualized (e.g., generated relationships, time-series data showing changes in sensor data over time, etc.) via web-based or application-based graphical user interfaces.

Referring generally to the FIGURES, systems and methods for automatically generating relationships (e.g., source-load relationships) between building systems are disclosed, according to various exemplary embodiments. Correlations between source systems such as air-handling units and load devices such as variable air volume devices can be determined by selectively activating the source systems and monitoring the response, if any, from sensors of the load devices. The correlations can be utilized to define control schedules for the building systems, detect faults, fill data gaps in faulty or malfunctioning sensors, and optimization of building-wide behavior to increase system performance. These techniques can be performed at the edge on one or more building systems, by a server, or by a cloud computing system. As utilized herein, the term “server” can include any type of computing device (e.g., application server, Internet/web server(s) or cloud-based server(s), a computing device such as an edge computing device having software/firmware configured to cause the device to have server capabilities/functionality, etc.), and is not restricted to a particular architecture.

Building with Building Systems

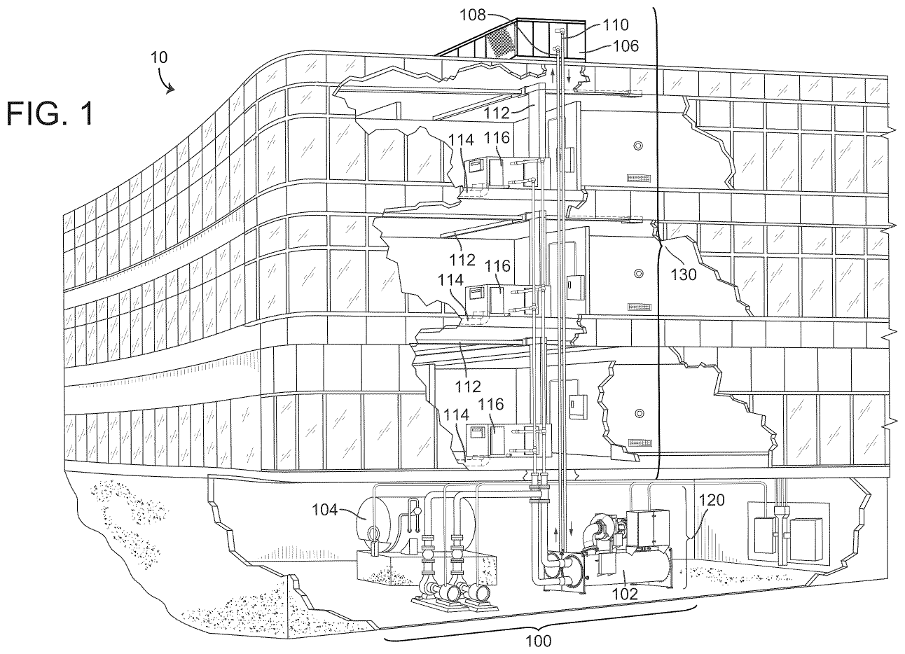

Referring now to FIGS. 1-4, an exemplary BMS and HVAC system in which the systems and methods of the present disclosure can be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof.

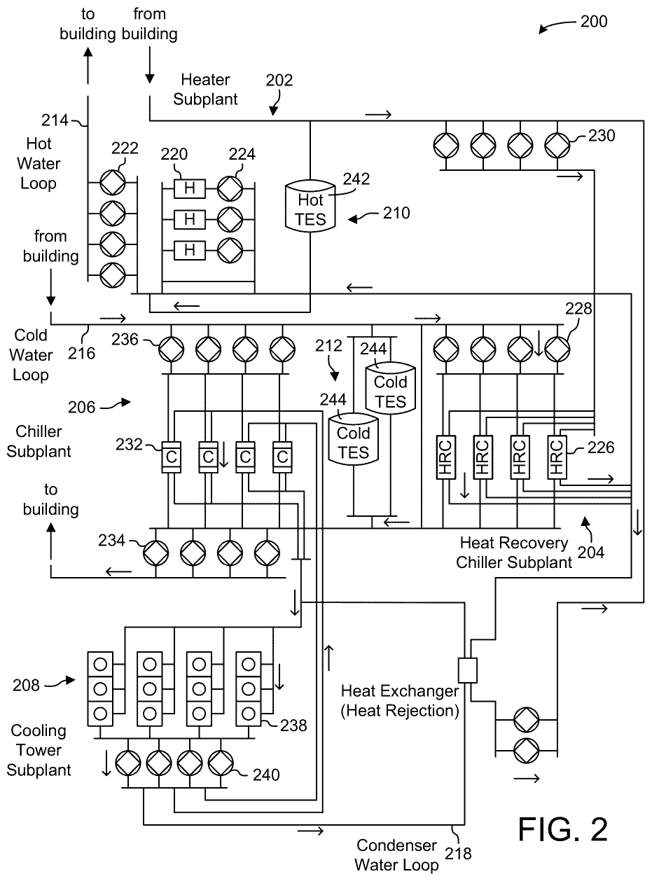

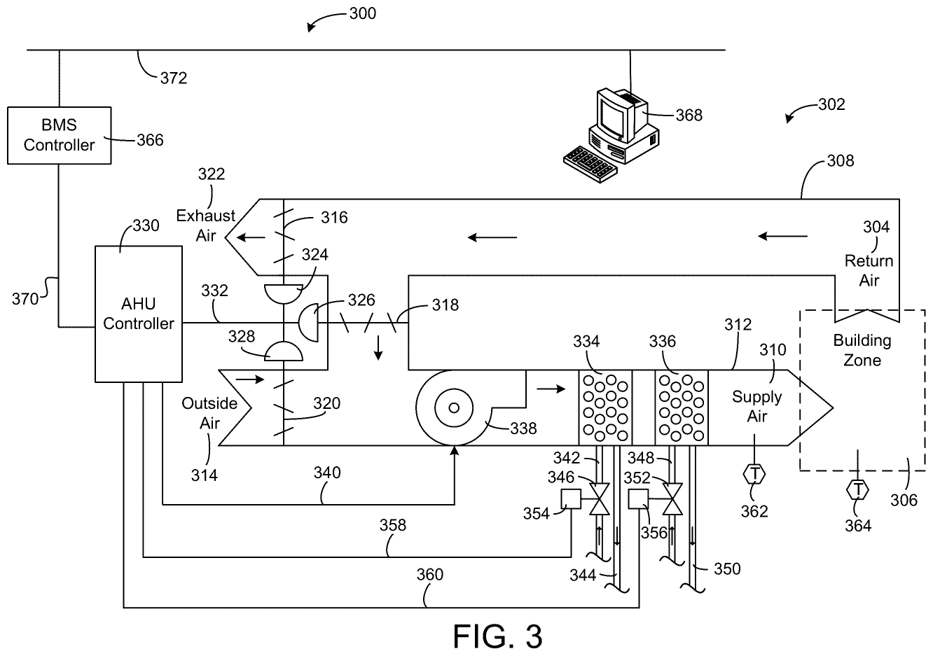

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

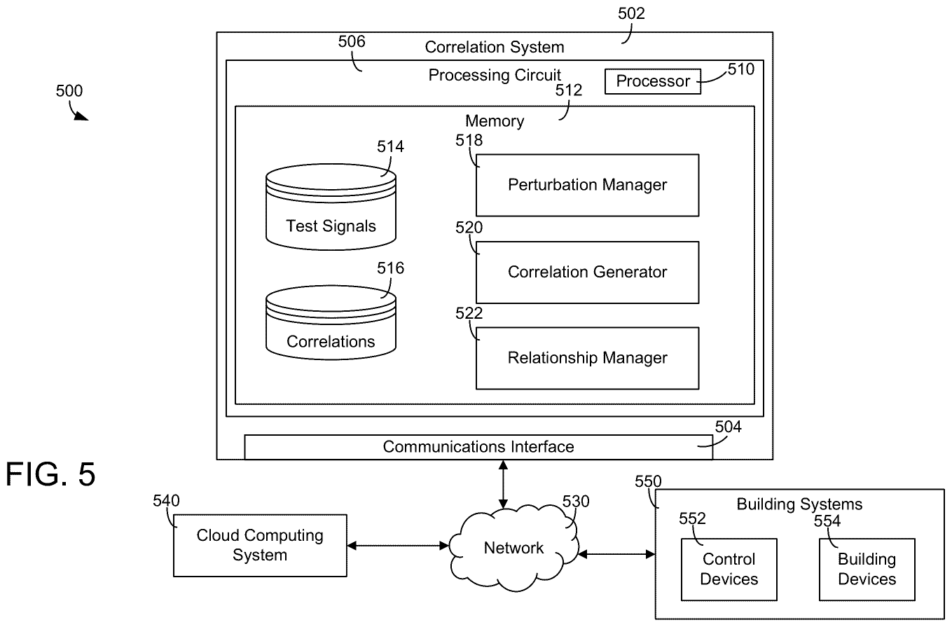

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328. AHU controller 330 may also implement one or more test signals received from another computing system, such as the correlation system 502 described in connection with FIG. 5.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building automation system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

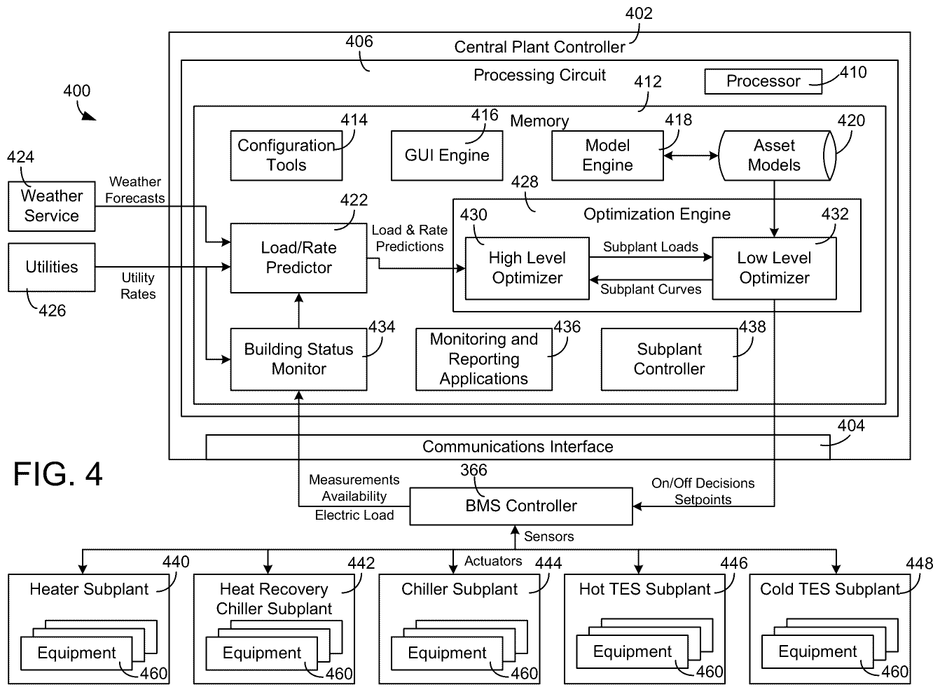

Referring now to FIG. 4, a block diagram of a building automation system (BMS) 400 is shown, according to some embodiments. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., cybersecurity, efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super-system. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shutdown systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Auto-Perturbation and Source-Load Relationship Management

Relationships between building devices that are undefined in a building configuration can be determined based on correlations between the output of a source system (e.g., an AHU, etc.) and a sink or load system (e.g., a VAV, etc.). The correlation can be determined based on the similarities in changes detected in time-series data retrieved from the source and load devices. In the case of an HVAC system, the AHU return temperature can be compared with the VAV room air temperature of one or more VAVs to determine whether it is likely that the aforementioned AHU serves the one or more VAVs.

Any suitable correlation technique can be utilized to perform the analysis between sensor data from different building systems, such as a variance inflation factor (VIF) or a cross correlation (e.g., with predetermined or dynamically determined time shift/lag), which can highlight features that have the highest multi-collinearity. In some implementations, time normalization can be applied prior to determining the correlation between multiple building data signals. Once the outputs of the source and load devices have been obtained, a combined output where both methods point to the same source-load link is generated, which can reduce instances of false associations. Similar approaches can be utilized for different source-load devices, such as building water distribution systems. Sensor data utilized to detect the correlations between building systems can include air temperature, air pressure, water temperature, or water pressure, among others.

To define correlations between many systems in a building, the systems and methods described herein can utilize auto-perturbation techniques to automatically activate and de-active devices according to one or more test signals. The test signals can define a schedule and pattern for activating various source devices in the building, and for observing sensor data for candidate load devices. By utilizing the aforementioned correlation techniques in combination with the auto-perturbation schedule and pattern of the source devices, relationships can be determined for all source-type and load-type systems within the building. The auto-perturbation process can be scheduled according to minimize the day-to-day impact of building use (e.g., outside of working hours, etc.).

The auto-perturbation techniques can be utilized during building setup (e.g., commissioning). For example, after installing HVAC systems or water systems within the building according to a predetermined plan, the aforementioned techniques can be utilized to verify that each source system (e.g., each AHU) is properly serving designed load systems. Various test signals can be utilized to generate activation patterns for source systems and monitoring patterns for load systems. Data collected from the source and load systems can be compared to an expected performance profile of the system to verify that the building systems are operating correctly. If a fault (e.g., unexpected behavior, data gaps, etc.) is detected, additional test signals can be generated or utilized to diagnose the fault in the system.

If a fault indicates a data gap in a particular sensor, the system can generate virtual sensor points based on the correlations between sensor readings within the building. Data gaps (e.g., missing sensor data when sensors go offline) can be estimated based on the relationships between source systems and different load systems. For example, based on the automatic correlation techniques described herein, a first sensor and a second sensor may be determined to respond similarly (e.g., proportionally by some determined factor) to a particular source. If the first sensor goes offline, the relationship with the second sensor can be utilized (e.g., the proportional factor) to generate virtual data points (e.g., estimated sensor data) based on the readings from the second sensor.

Additionally, the auto-perturbation techniques described herein can comprehensively model the relationships between all source-load systems within a building, such that the control scheme for said systems can be optimized for one or more metrics (e.g., power efficiency, temperature or pressure targets, etc.). For example, the correlations determined using the techniques described herein can indicate a degree by which one building system affects another building system. These relationships can be utilized to optimize the on-time and off-time of different building systems to improve building efficiency when compared to control systems that are unaware of building system relationships.

Execution of the present techniques may be performed locally in a building server (e.g., the central plan controller 402, the BMS controller 366, another local building server or servers, etc.), remotely by one or more servers that manage systems of one or more buildings, or by a cloud computing system. Processing efficiency can be optimized by transmitting local sensor data captured via the sensors of the various building systems described herein to the remote server, which can perform batch calculations and analysis, generate or select test signals, and provide control data or other diagnostic data to local building computing systems. Various information relating to the techniques described herein can be visualized (e.g., generated relationships, time-series data showing changes in sensor data over time, etc.) via web-based or application-based graphical user interfaces. The techniques described herein may be performed according to a regular or periodic schedule, for example, to periodically monitor and verify the efficiency of the system in different seasons or under different external or internal conditions. These and other techniques are described in further detail herein.

Referring now to FIG. 5, illustrated is a block diagram of a system 500 for automatically generating relationships in building systems, according to some embodiments. The system 500 is shown to include a correlation system 502, a network 530, a cloud computing system 540, and one or more building systems 550. While shown in the system 500 as singular components, each of correlation system 502, the cloud computing system 540, and the building systems 550 may be implemented across multiple devices (e.g., via distributed computing architectures, multiple discrete devices, etc.).

The correlation system, the cloud computing system 540, and the building systems 550 may each include computing devices or systems that include a processor and memory for storing and executing instructions. Said memory may include one or more devices (e.g., RAM, ROM, Flash memory, hard disk storage, etc.) for storing data or computer code for completing or facilitating the various processes, layers, and modules described herein. The memory may be or include volatile memory or non-volatile memory and may include database components, object code components, script components, or any other type of information structure for supporting the various activities and information structures described in the present application.

The correlation system 502 is shown to include a processing circuit 506, which includes a processor 510 and a memory 512. It will be appreciated that these components can be implemented using a variety of different types and quantities of processors and memory. For example, processor 510 can be a general-purpose processor, an ASIC, one or more FPGAs, a group of processing components, or other suitable electronic processing components. Processor 510 can be communicatively coupled to memory 512. While processing circuit 506 is shown as including one processor 510 and one memory 512, it should be understood that, as discussed herein, a processing circuit or memory may be implemented using multiple processors or memories in various embodiments. All such implementations are contemplated within the scope of the present disclosure.

Memory 512 can include one or more devices (e.g., memory units, memory devices, storage devices, etc.) for storing data and/or computer code for completing and/or facilitating the various processes described in the present disclosure. Memory 512 can include random access memory (RAM), read-only memory (ROM), hard drive storage, temporary storage, non-volatile memory, flash memory, optical memory, or any other suitable memory for storing software objects and/or computer instructions. Memory 512 can include database components, object code components, script components, or any other type of information structure for supporting the various activities and information structures described in the present disclosure. Memory 512 can be communicably connected to processor 510 via processing circuit 506 and can include computer code for executing (e.g., by processor 510) one or more processes described herein.

Memory 512 is shown to include a perturbation manager 518, which can activate one or more of the building systems 550 (e.g., the control devices 552, the building devices 554) to perform the various functionality herein. For example, the perturbation manager 518 can execute, provide, or otherwise activate the one or more building systems 550 according to one or more test signals 514. The perturbation manager 518 can select one or more test signals 514 according to a predetermined test schedule, or may generate test signals 514 to perform the various perturbation techniques described herein.

Memory 512 is also shown to include a correlation generator 520, which can monitor signals from the building systems 550 (e.g., the building devices 554, the control devices 552, etc.). The correlation manager 520 can generate one or more correlations 516 between one or more control devices 552 and one or more building devices 554, as described in further detail herein. The correlation generator 520 can receive time-series sensor data (e.g., air temperature data, air pressure data, water temperature data, water pressure data, etc.) from the building systems 550 according to one or more predetermined schedules (which may be specified as part of the test signals 514). The correlation generator 520 may calculate one or more correlation scores between the time series data received from the building systems 550. For example, the correlation generator 520 may calculate the variance inflation factor (VIF) between time series data received from a control device 552 and a building device 554, for example. The results of the VIF calculation can be stored as a correlation score between the two building systems 550, which can indicate a likelihood that the control device 552 serves the building device 554, for example.

The variance inflation factor can be utilized to check for multi-collinearity in one or more datasets. This important for statistical modelling because not having collinear features in the datasets is a baseline requirement. The correlation generator 520 can utilize VIF to identify multi-collinearity in features from different datasets (e.g., from source data sets corresponding to a control device 552 and a load dataset corresponding to a building device 554, etc.). The correlation generator 520 can rank each load dataset with respect to the collinearity score.

In some implementations, the correlation generator 520 can generate one or more cross correlations between the time series data received from the building systems 550. Cross correlation can be a measure to quantify a similarity between two signals (e.g., sensor signals as time series data from the building systems 550) as a function of the displacement of one signal relative to the other signal. Calculating the cross-correlation can include shifting one signal across another and computing the similarity between the at each shift. The shift amounts can be predetermined or may be a function of the size of the signal(s). If the signals are similar, the cross-correlation will yield large values when the signals overlap, indicating a strong correlation. Conversely, if the signals are dissimilar, the cross-correlation will produce smaller values.

Additionally, the correlation generator 520 can determine the time shift between two signals, which can be indicative of a time period between when one building system 550, when activated, affects the performance of another part of the building (e.g., corresponding to or otherwise monitored by another building system 550). As described herein, in cross-correlation, the lag (or displacement) between two signals (e.g., in time) specifies how much one signal is shifted relative to the other during the cross-correlation operation. The lag (in this example, time shift) can be determined by systematically shifting one signal (e.g., data from one of the building systems 550) relative to the other signal and computing the cross-correlation at each shift. The lag corresponding to the maximum cross-correlation value indicates the optimal alignment between the two signals. This lag value represents the time delay or displacement between the signals. The sign of the lag indicates which signal lags or leads relative to the other signal.

In some implementations, the correlation generator 520 can perform any suitable correlation technique using time series data and/or frequency domain data. For example, the correlation generator 520 may perform a Fourier transform operation, such as a fast Fourier transform (FFT) operation to generate frequency domain representations of the time series data captured from the one or more building systems 550. In some implementations, the correlation generator 520 can use the determined time shift to perform normalize both signals. Normalizing each signal can involve scaling the signals to bring signals into a common scale (e.g., make them comparable in terms of their magnitudes, etc.).

Once normalized, in some implementations, the correlation generator 520 can determine a Pearson correlation between the normalized data from the building systems 250. The Pearson correlation can be a measure of the linear relationship between two signals, and can quantify the strength and direction of the linear association between the normalized data from the building systems 550. The Pearson correlation can be calculated in addition to, or as an alternative to a VIF correlation or a cross correlation. In implementations where the Pearson correlation is an additional correlation, the Pearson correlation can be used to filter false positive associations between building systems 550.

To do so, to determine whether one building system 550 influences or otherwise causes changes in data captured by another building system 550, the correlation generator 520 can determine whether the Pearson correlation indicates a linear relationship between signals, and that the VIF or cross correlation indicates an association. If either correlation does not indicate an association greater than a corresponding threshold, the correlation generator 520 can determine that said building systems 550 are not associated with one another. For example, if the VIF correlation or cross correlation indicates a potential association, but the Pearson correlation does not indicate an association (e.g., the magnitude of the Pearson correlation is below a threshold, etc.), the association can be removed as a false positive. In some implementations, these techniques can be used to evaluate and potentially remove existing associations between building systems 550 (e.g., to remove as false positives).

The use of VIF, cross correlation, and Pearson correlation (as well as the determination of time shift) provides a number of advantages over other correlation techniques. For example, other techniques, such as discrete cosine transform (DCT), are limited to linear relationships between datasets, are sensitive to data pre-processing techniques, and are not specific to multicollinearity detection (and therefore may lack accuracy or may not provide adequate measures of multicollinearity). In contrast, the techniques described herein utilize VIF, cross correlation, and/or Pearson correlation, which provide a number of advantages over other correlation techniques. For example, VIF can directly and accurately quantify the text of multicollinearity between datasets. Further, VIF, cross correlation, and/or Pearson correlation can accommodate different types of relationships between variables, including nonlinear relationships.

Memory 512 is also shown to include a relationship manager 522, which can generate relationships (e.g., in a building schema, for future configurations, etc.) between one or more control devices 552 and one or more building devices 554 based on the correlations 516 generated by the correlation generator 520. To generate relationships between building systems 550, the relationship manager 522 can compare corresponding correlation scores in the correlations 516 to one or more thresholds. For example, if the relationship manager 522 determines that a correlation score between a control device 552 and a building device 554 is greater than or equal to a predetermined threshold, the relationship manager 522 can define a relationship between the control device 552 and the building device 554.

The defined relationship between any two building systems 550 can be determined based on the type of devices for which the relationship is generated. For example, if the relationship manager 522 generates a relationship between a control device 552 (e.g., an AHU, etc.) and a building device 554 (e.g., a VAV, an air sensor, etc.), the relationship manager 522 can define the relationship as a source-load relationship. In some implementations, the relationship manager 522 can define a relationship between two building devices 554 or two control devices 552. For example, the relationship manager 522 can define a relationship between two building devices 554 that indicates both building devices 554 are served by the same control device 552, for example. The degree to which the sensor data captured from the two building devices 552 is proportional to one another can be stored in association with the relationship.

In various embodiments, the relationship manager 522 can utilize the relationships to fill data gaps (e.g., missing sensor data when sensors go offline) by estimating virtual sensor data values. For example, the relationship manager 522 can determine, based on the relationships and the correlations 516, that a first sensor of a first building device 554 and a second sensor of a second building device 554 respond similarly (e.g., proportionally by some determined factor) to a particular source (e.g., a control device 552). If the relationship manager 522 determines that the first sensor has gone offline (e.g., the sensor is providing data outside of normal operational limits, fails to provide data, provides null or zero data, etc.), the relationship manager 522 can utilize the relationship with the second sensor (to generate virtual data points (e.g., estimated sensor data) based on the readings from the second sensor of the second building device 554.

To so do, the relationship manager 522 can multiply or transform the sensor data using the proportional factor of the relationship determined by the relationship manager 522. For example, when generating a relationship between building devices, if the relationship manager 522 determines that the correlations 516 indicate a VIF, cross correlation, and/or Pearson correlation between two building devices 554 is greater than a predetermined threshold, the relationship manager 522 can determine a proportionality factor between the two building devices 554 when those building devices 554 are served by a respective control device 552. The proportionality factor can be a scalar value that is calculated by dividing the rolling average of the sensor data of the first building device 554 by the rolling average of the sensor data of the second building device 554. Because the sensor data from the building devices 554 in this example moves similarly together (as indicated by the VIF, cross correlation, and/or Pearson correlation exceeding a threshold), the proportional factor can be utilized to generate “virtual” sensor data points for the offline sensor. These virtual data points can be stored in association with an identifier of the building device 554 for which they are generated, and can include an indication that the data points are virtual.

When the offline sensor is detected as coming back online (e.g., message from a maintenance computing device, valid data from the sensor is received, etc.), the relationship manager 522 can determine whether the virtual data points generated during the offline period are valid by checking the correlation score between the offline points during the offline period and the new sensor data received during similar activity levels (e.g., when an associated control device 552 is activated in a similar pattern or according to a similar schedule) to validate the accuracy of the virtual data points. In such implementations, a higher correlation score between the virtual data points and the new data points can indicate that the new sensor data accurately reflects the expected behavior of the building systems 550.

The relationship manager 522 can further determine whether the relationships generated using the correlations 516 match those of a predetermined building schema, for example, during commissioning of a building. When a building is commissioned, a predetermined building schema (e.g., a Brick or Haystack schema, etc.) can include one or more designated relationships between one or more control devices 552 and one or more building devices 554. The relationships in the building schema, however, may not be accurate (e.g., out of data, does not reflect faults or design changes, etc.). The relationship manager 522 can compare the relationships generated based on the correlations 516 between one or more control devices 552 and one or more building devices 554 to detect whether any relationships are missing or incorrect in the building schema. For example, the relationship manager 522 can iterate through the generated relationships to identify each relationship associated with each building system 550. If the relationship manager 522 determines that all building relationships generated based on the correlations 516 are present in the building schema, the relationship manager 522 can determine that the building schema is accurate. Otherwise, the relationship manager 522 can determine that the building schema is missing one or more relationships, or that one or more relationships are incorrect in the building schema. The relationship manager 522 can record these issues in one or more data structures in the memory 512 of the correlation system, or provide indications of the inconsistencies to an external computing system (e.g., the cloud computing system 540, a user device via a graphical user interface, etc.).

In some implementations, the relationship manager 522 can define a relationship between two building systems 550 based on a corresponding identifier of the building systems 550. For example, in some implementations, the relationship manager 522 can parse one or more BACnet properties of each building system 550 to retrieve an identifier, such as a native reference value. In some implementations, the native reference for building equipment or a data point of building equipment can indicate one or more controllers in communication with said building equipment. Upon parsing said identifiers, the relationship manager 522 can access a database of controllers or other building devices associated with the building to identify a match between the controller identified in the native reference. If a match is identified, the relationship manager 522 can generate an association between the building systems 550.

The perturbation manager 518, the correlation generator 520, and the relationship manager 522 can operate according to one or more schedules to utilize the techniques described herein to periodically verify whether any of the building systems 550 are experiencing a fault. For example, after establishing a baseline set of relationships that are known to be accurate, the perturbation manager 518, the correlation generator 520, and the relationship manager 522 can periodically perform the various techniques described herein to determine whether there any relationships have been changed between the building systems 550, which may indicate a fault in a building device 554 or a control device 552. For example, the perturbation manager 518, the correlation generator 520, and the relationship manager 522 can perform the techniques described herein on a monthly basis, a bi-monthly basis, a quarterly basis, or a yearly basis to detect any changes to the relationships between building systems 550. If any changes are detected (e.g., new relationships formed, existing relationships no longer being present, etc.), a flag can be set in the memory 512 of the correlation system that indicates the changed relationships. These changed relationships can be presented to a user via a graphical user interface of a user device, or provided to a cloud computing system 540 for presentation in a web-based interface, for example.

The relationship manager 522 can, in some implementations, store the relationships as part of a building schema, or update an existing building schema, for the building that includes the building systems 550. The building schema can be updated to optimize the on-time and off-time of the control devices 552 and the building devices 554 to achieve desired building conditions (e.g., air temperature, air pressure, water temperature, water pressure, etc.) during predetermined time periods (e.g., while the building is occupied, while the building is not occupied, etc.). The relationship manager 522 can generate relationships between building devices for different time periods. For example, certain building equipment (e.g., heating equipment) may affect different sensors differently depending on the season (e.g., winter versus summer). Determination of faults in the building systems 550 can be further based on the climate, location, and time of year for the building.

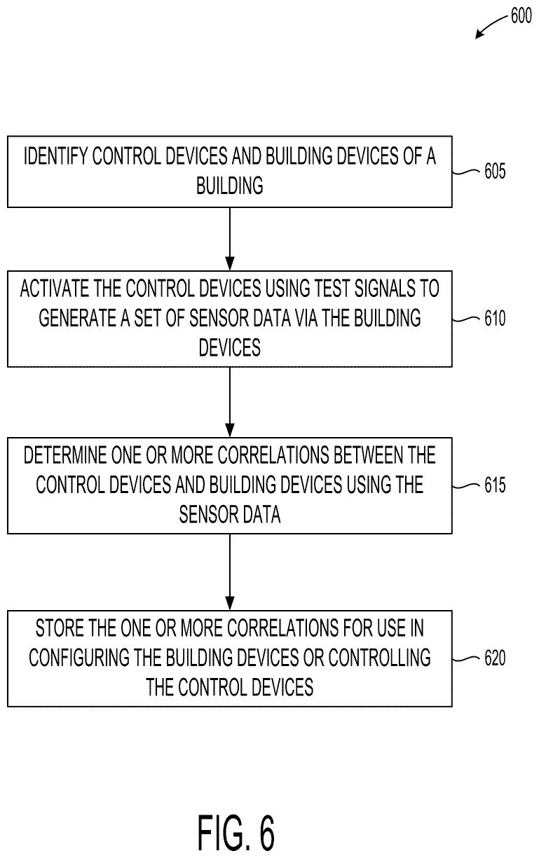

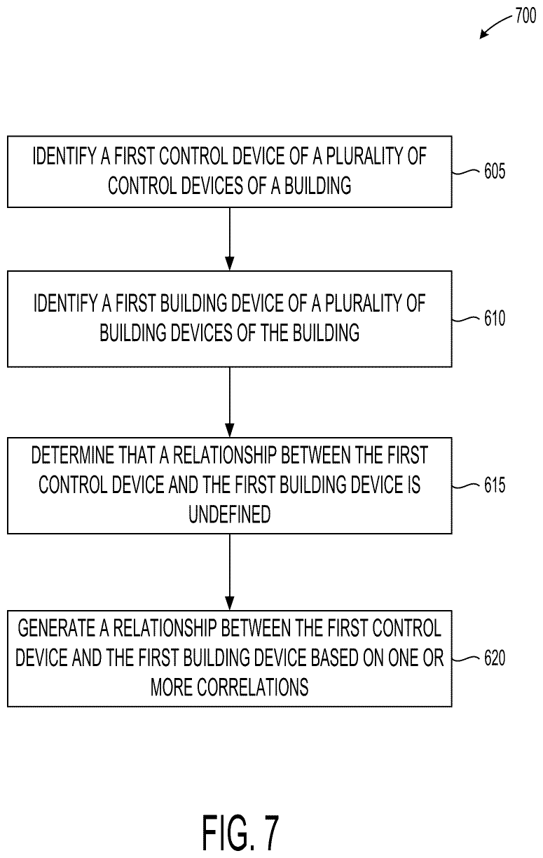

The memory 512 is shown as storing the test signals 514. The test signals 514 can include any signals, schedule, or activation pattern for the control devices 552 or the building devices 554. For example, the test signals 514 can include an activation pattern for a diagnostic program that iteratively activates each of the control devices 552 one at a time, to identify relationships between one or more control devices 552 and one or more building devices 554 of the building systems 550. In some implementations, one or more test signals 514 can be generated using various techniques described herein (e.g., techniques described in connection with FIGS. 6 and 7, etc.). In some implementations, the test signals 514 can include signals that indicate data (e.g., sensor data, etc.) from one or more building devices 554 or control devices 552 is to be monitored in response to activating or deactivating one or more of the control devices 552.

The test signals 514 can include signals that include instructions to activate or deactivate one or more control devices 552 or building devices 554 according to a predetermined schedule. For example, the test signals 514 can include signals to turn on at least one control device 552 while deactivating all other control devices 552 of a building for a predetermined duration, during a predetermined time of day, month, year, or other time period. The test signals 514 can cause the correlation system 502 (or the components thereof) to communicate via the communications interface with one or more of the building systems 550 to activate or deactivate the building systems to perform auto-perturbation and auto-discovery of relationships, as described herein. The test signals 514 may be generated by the components of the correlation system 502, defined by an administrator of the correlation system 502 (e.g., via user input to the correlation system, via user input to a user device in communication with the correlation system 502, etc.), or received or retrieved from the cloud computing system 540 via the network 530.

In some implementations, the test signals 514 can include indications of one or more activation parameters for the control devices 552 or the building devices 554. The activation parameters may be temperature or pressure set points for an AHU (e.g., a control device 552), for example. In some implementations, the test signals 514 can specify one or more mathematical operations to calculate correlations resulting from the test signals 514. For example, the test signals 514 can include instructions to subtract return air temperatures to focus on the impact of terminal unit (e.g., building device 554) temperature changes caused by a source AHU (e.g., a control device 552).

The memory 512 is shown as storing the correlations 516, for example, in one or more data structures. The correlations 516 can be generated by the correlation generator 520, and can include correlation scores between different control devices 552 and building devices 554, for example. In some implementations, the correlations 516 can include correlation scores between two or more control devices 552, or two or more building devices 554. The correlations 516 can be generated as VIF scores, cross correlation scores, and/or Pearson correlation scores based on time-series sensor data received or retrieved from the control devices 552 or the building devices 554. The correlations 516 can be generated based on the sensor data captured according to the test signals 514. The correlations 516 can each be stored in association with identifiers of the respective control devices 552 or building devices 554 to which the respective correlations correspond, identifiers of the test signals 514 used to generate the correlations 516, timestamps identifying when the correlations 516 were generated, pointers or identifiers of the time-series data used to generate the correlations 516 (e.g., which may be stored in the memory 512), or identifiers of one or more relationships generated based on the correlations 516. The correlations 516 can be communicated to external computing devices, such as user devices, administrator-computing devices, or the cloud computing system 540, for example.

The correlation system 502 (or the components thereof) can communicate with one or more external devices via the network 530. The network 530 can communicatively couple the devices and systems of the system 500. In some embodiments, the network 530 is at least one of or a combination of a Wi-Fi network, a wired Ethernet network, a ZigBee network, a Bluetooth network, BACnet network, or any other wireless network. The network 530 may be a local area network or a wide area network (e.g., the Internet, a building WAN, etc.) and may use a variety of communications protocols (e.g., BACnet, IP, LON, etc.). The network 530 may include routers, modems, servers, cell towers, satellites, and/or network switches. The network 530 may be a combination of wired and wireless networks. Although only one building system 112 is shown in the system 500 for visual clarity and simplicity, it should be understood that any number of building systems 550 (corresponding to any number of buildings) can be included in the system 500 and communicate with the correlation system 502 as described herein.

The network 530 can be configured to facilitate communication and routing of messages between the correlation system 502 and the building systems 550 (e.g., including the control devices 552 or the building devices 554), or any other system. The correlation system 502 can include any of the components described herein, and can implement any of the processing functionality of the devices described herein. In an embodiment, the correlation system 502 can host a web-based service or website, via which a user device can access one or more user interfaces to coordinate various functionality described herein. In some embodiments, the correlation system 502 can facilitate communications between various computing systems described herein via the network 530.

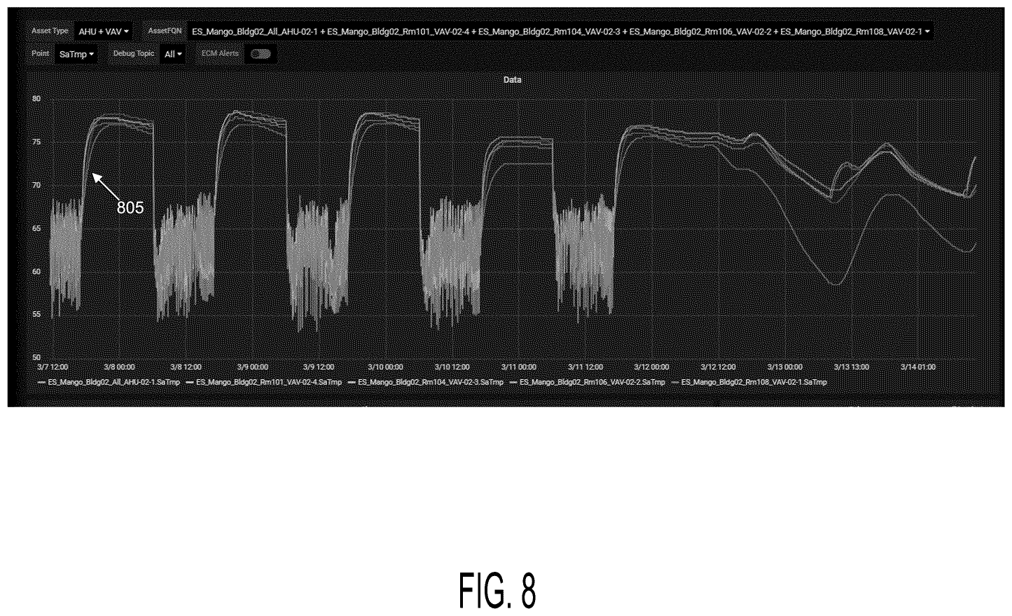

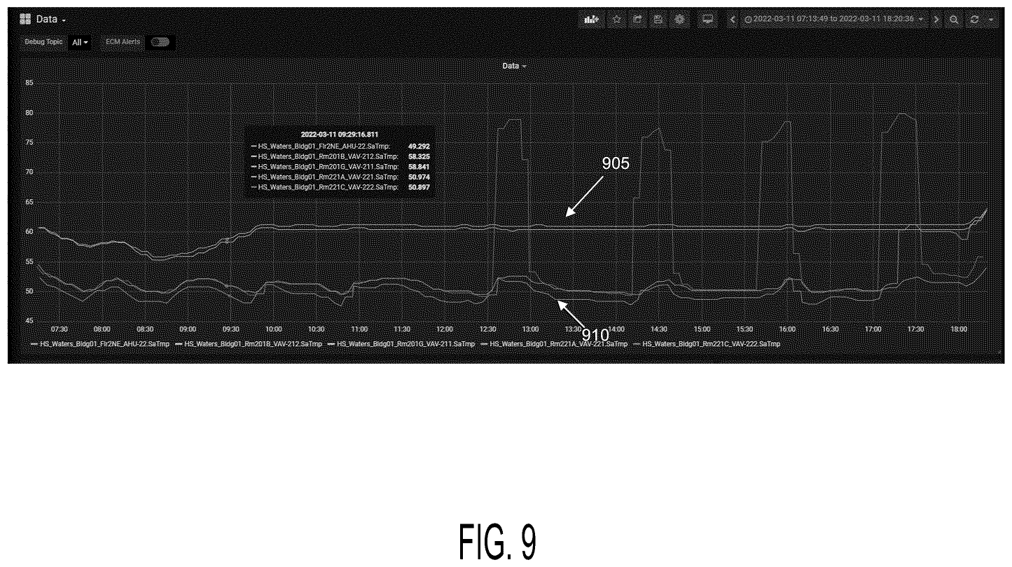

The cloud computing system 540 can be any type of cloud computing platform, which may communicate with the building systems 550 (e.g., including the control devices 552 or the building devices 554), the correlation system 502, or any other system as described herein. In some implementations, the cloud computing system 540 can perform one or more functionalities of the correlation system 502. For example, the cloud computing system 540 may perform the functionality of the perturbation manager 518, the correlation generator 520, or the relationship manager 522, or may store, generate, or provide one or more test signals 514, or the correlations 516 for one or more buildings. The cloud computing system 540 can store or present data received from the correlation system, for example, in one or more user interfaces via a web-based interface (e.g., a webserver, etc.). The cloud computing system 540 may present visualizations of one or more of the correlations 516 or relationships generated for the building systems 550 described herein, and may provide graphs indicating various sensor data captured from the building systems (e.g., as described in connection with FIGS. 8 and 9).

The building systems 550 can be any type of system that may be disposed within or for a building, any may include any of the devices, systems, or computing devices described in connection with FIGS. 1, 2, 3, or 4. The building systems 550 can include the control devices 552 and the building devices 554. The control devices 552 can include any type of device or system that is responsible for controlling a physical parameter of the building, such as an AHU or a waterside system, among others. The control devices 552 can include sensors that provide data relating to the particular control device, such as return air temperature, return air pressure, return water temperature, or return water pressure, among others. The control devices 552 may be referred to as “source devices” or “source systems,” because they can provide a “source” (e.g., air, water) that is “consumed” by “load devices” or “load systems” within the building. The building devices 554 can include any type of device that can monitor the physical parameters of the building that are controlled at least in part by the control devices 552. For example, the building devices 554 can include sensors (e.g., air temperature, air pressure, water temperature, water pressure, etc.) within VAVs, or other types of devices within a building that are coupled to an AHU or to a waterside system. The building devices 554 may also include air or water temperature or pressure sensors disposed in various spaces of the building, for example. The building devices 554 and the control devices 552 of the system 500 can provide various sensor data described herein to the correlation system 502 or the cloud computing system 540 via the network 530 (and/or via one or more intermediary devices or servers).

Referring now to FIG. 6, a flowchart of an example process 600 for automatically defining control relationships between building systems is shown, according to some embodiments. Process 600 may be implemented by the system 500, for example, and at least in part by the correlation system 502. As described above, the correlation system 502 can automatically identify relationships between building devices (e.g., the building devices 554) and control devices (e.g., the control devices 552) based on time-series data received or retrieved from said building systems. It will be appreciated that certain steps of process 600 may be optional and, in some embodiments, process 600 may be implemented using less than all of the steps, or steps perform in alternative orders.

At step 605, the one or more control devices (e.g., the control devices 552) and one or more building devices (e.g., the building devices 554) of a building are identified. As described herein, the control devices can include any type of building system that can control a physical parameter (e.g., air temperature, air pressure, water temperature, water pressure) of a building. For example, the control devices may include air handler units. The control devices can include sensors that provide data relating to the particular control device, such as return air temperature, return air pressure, return water temperature, or return water pressure, among others. The control devices may be referred to as “source devices” or “source systems,” because they can provide a “source” (e.g., air, water) that is “consumed” by “load devices” or “load systems” within the building.

The building devices can include any type of device that can monitor the physical parameters of the building that are controlled at least in part by the control devices. For example, the building devices can include sensors (e.g., air temperature, air pressure, water temperature, water pressure, etc.) within VAVs, or other types of devices within a building that may be connected to an AHU or to a waterside system. The building devices can be or may include a variable air volume device. The building devices may also include air or water temperature or pressure sensors disposed in various spaces of the building, for example.

The building devices and the control devices of the building can be identified, for example, by communicating with one or more building servers that maintain a registry, lookup table, or repository that stores identifiers of the control devices and building devices of the building. In some implementations, the correlation system (and/or one or more intermediary devices or servers) can perform a discovery process (e.g., by communicating with one or more local building computing systems or gateways) to identify the building control devices and the building devices. In some implementations, the control devices and building devices may be identified by a building schema (e.g., a Brick schema) stored locally at the correlation system.

At step 610, the control devices are activated using one or more test signals (e.g., the test signals 514) to generate a set of sensor data via the building devices. The test signals can define a schedule and pattern for activating one or more of the identified control devices in the building, and for observing sensor data retrieved or received from the building devices (and in some implementations, from the control devices. Activating the control devices automatically is sometimes referred to herein as auto-perturbation, and can include activating the control devices for predetermined time periods (e.g., 1-minute, 5 minutes, 10 minutes, half an hour, one hour, three hours, etc.).

The test signals 514 can include any signals, schedule, or activation pattern for the control devices or the building devices. For example, the test signals can include an activation pattern for a diagnostic program, that iteratively activates each of the control devices one at a time, to identify relationships between the identified control devices and building devices. In some implementations, the test signals can include signals that indicate data (e.g., sensor data, etc.) from one or more building devices or control devices is to be monitored in response to activating or deactivating one or more of the control devices.

The test signals can include signals that include instructions to activate or deactivate one or more control devices or building devices according to a predetermined schedule. For example, the test signals can include signals to turn on at least one control device while deactivating all other control devices of a building for a predetermined duration, during a predetermined time of day, month, year, or other time period. The test signals can cause the correlation system (or the components thereof) to communicate via the communications interface with the control devices or the building devices to activate or deactivate the building systems to perform auto-perturbation and auto-discovery of relationships, as described herein.

The test signals may be generated by the components of the correlation system, defined by an administrator of the correlation system (e.g., via user input to the correlation system, via user input to a user device in communication with the correlation system, etc.), or received or retrieved from a cloud computing system via a network. In some implementations, the test signals can be generated, for example, upon detecting that a particular building device has gone offline, or if a fault has been detected in one or more building devices or control devices in the building. For example, test signal templates may include an outline of various testing procedures that can be performed for different types of control devices or building devices when a fault is detected in a particular control device or building device.

Upon detecting an instance of a fault, the correlation system can utilize the test signal template to implement the testing procedures for the building devices or control devices corresponding to the respective fault. For example, the correlation system may generate test signals that follow a predetermined activation pattern (e.g., indicated in the template) to diagnose the fault by activating or deactivating corresponding control devices or building devices. In some implementations, the correlation system can compare or correlate (e.g., using VIF, cross correlation, Pearson correlation, etc.) actual data and data from expected models of damaged or faulted equipment (e.g., which may be gathered from simulated error states in addition to simulations of expected data) to diagnose individual faults upon detecting deviations from expected behavior in the building. In doing so, the correlation system can both detect and diagnose faults as they occur based on the sensor data retrieved from one or more building devices.

In some implementations, the auto-perturbation techniques can be utilized during building setup (e.g., commissioning). For example, after installing HVAC systems or water systems within the building according to a predetermined plan, the aforementioned techniques can be utilized to verify that each control device (e.g., source system) is properly serving designated building devices (e.g., load devices). Various test signals can be utilized to generate activation patterns for control devices and monitoring patterns for building devices. Data collected from the control devices and building devices can be compared to an expected performance profile of the building to verify that the building systems are operating correctly, as described herein. Additionally, the test signals may include signals that comprehensively model the relationships between the control devices and building devices within a building, such that the control scheme for said systems can be optimized for one or more metrics (e.g., power efficiency, temperature or pressure targets, etc.).

In some implementations, the test signals can include a pre-determined activation pattern for the control devices. In some implementations, to determine the relationships between control devices and building devices of a building, the control devices may be activated iteratively, one at a time. For example, the a first control device of the building can be activated for a first predetermined time period while the other control devices of the building are de-activated for the first predetermined time period. After a predetermined activation duration, a second control device of the building can be activated a second predetermined time period, while the other control devices (including the first control device) may be de-activated for the second predetermined time period.

While the control devices are activated, the correlation system can request, receive, or retrieve sensor data from the building devices (and in some implementations, the control devices). The sensor data can be any type of sensor data that may be gathered from sensors of the building devices (e.g., air temperature data, air pressure data, water temperature data, water pressure data, accelerometer data, vibration data, etc.). The sensor data can be retrieved and stored in association with an identifier of the respective building device or control device to which the sensor data corresponds. The sensor data may be time-series data. The sensor data may be stored as a set of time-series data structures in association with the respective test signals (e.g., the activation program or schedule) that were used to generate and gather the sensor data.

At step 615, one or more correlations between the control devices and the building devices are determined using the sensor data. The one or more correlations can be determined by calculating at least one variance inflation factor or at least one cross correlation based on the set of sensor data. For example, the VIF, cross correlation, and/or Pearson correlation can be calculated between a set of sensor data from a control device and a set of sensor data captured from one or more building devices over the same time period. The VIF can be a measure of the amount of multi-collinearity in a set of multiple regression variables. The one or more correlations can be calculated iteratively, for example, between each combination of control devices and building devices. In some implementations, the one or more additional correlations can be calculated based only on sensor data retrieved from multiple building devices (e.g., to detect which building devices have sensors that exhibit similar readings). Such correlations may be utilized, for example, to generate virtual sensor data as described herein.

Determining the one or more correlations may include generating a confidence score that indicates a strength of a relationship between at least one control device and at least one building device of the building. For example, the VIF, cross correlation, and/or Pearson correlation calculated using the time series data may itself be utilized as a confidence score. In some implementations, the confidence score may be calculated based on the VIF, cross correlation, and/or Pearson correlation (e.g., by multiplying the VIF, cross correlation, and/or Pearson correlation by a predetermined factor or otherwise transforming the VIF, cross correlation, and/or Pearson correlation, etc.). In some implementations, the confidence score may be calculated as a weighted sum of one or more of the VIF, cross correlation, and Pearson correlation. The confidence score may be compared to a predetermined threshold to determine whether the confidence score indicates a relationship. For example, if the confidence score is greater than or equal to 0.5, that may indicate a relationship between the control device and building device for which the confidence score was generated. If a relationship is indicated, a corresponding relationship between the devices can be generated in a building schema, or stored for future configuration or processing techniques. Similarly, if the confidence score is less than a predetermined threshold (e.g., less than 0.2), the confidence score may indicate that the respective building device and control device are unrelated. Similar techniques can be applied to generate relationships or detect invalid relationships between any device in the building.

At step 620, the one or more correlations are stored for use in configuring the building devices or controlling the control devices. As described herein, the relationships generated for the various control devices and building devise described herein can be utilized to configure (e.g., commission) and verify a building schema, generate virtual sensor data to fill data gaps (e.g., offline sensors), to detect faults within the building, or to optimize the operations of the building.

In some implementations, the correlation system can the correlation system can utilize the relationships to fill data gaps (e.g., missing sensor data when sensors go offline) by estimating virtual sensor data values. For example, the correlation system can determine, based on the relationships and the correlations, that a first sensor of a first building device and a second sensor of a second building device respond similarly (e.g., proportionally by some determined factor) to a particular source (e.g., a control device). If the correlation system determines that the first sensor has gone offline (e.g., the sensor is providing data outside of normal operational limits, fails to provide data, provides null or zero data, etc.), the correlation system can utilize the relationship with the second sensor to generate virtual data points (e.g., estimated sensor data) based on the readings from the second sensor of the second building device.

To so do, the correlation system can multiply or transform the sensor data using the proportional factor of the relationship determined by the correlation system. For example, when generating a relationship between building devices, if the correlation system determines that the correlations indicate a VIF, cross correlation, and/or Pearson correlation between two building devices is greater than a predetermined threshold, the correlation system can determine a proportionality factor between the two building devices when those building devices are served by a respective control device. The proportionality factor can be a scalar value that is calculated by dividing the rolling average of the sensor data of the first building device by the rolling average of the sensor data of the second building device. Because the sensor data from the building devices in this example moves similarly together (as indicated by the VIF, cross correlation, and/or Pearson correlation exceeding a threshold), the proportional factor can be utilized to generate “virtual” sensor data points for the offline sensor. These virtual data points can be stored in association with an identifier of the building device for which they are generated, and can include an indication that the data points are virtual.

In some implementations, the correlation system can detect a deviation from an expected value in the set of virtual sensor data. For example, when the offline sensor is detected as coming back online (e.g., message from a maintenance computing device, valid data from the sensor is received, etc.), or the sensor of the building device has been replaced, etc., the correlation system can determine whether the virtual data points generated during the offline period are valid by checking the correlation score between the offline points during the offline period and the new sensor data received during similar activity levels (e.g., when an associated control device is activated in a similar pattern or according to a similar schedule) to validate the accuracy of the virtual data points. In such implementations, a higher correlation score between the virtual data points and the new data points can indicate that the new sensor data accurately reflects the expected behavior of the building systems.

In some implementations, the correlation system can verify the accuracy of a building schema of a building (e.g., a Brick schema) by comparing the one or more correlations to a set of expected correlations of the building schema. For example, the correlation can determine whether the relationships generated using the correlations match those of a predetermined building schema, for example, during commissioning of a building. When a building is commissioned, a predetermined building schema can include one or more designated relationships between one or more control devices and one or more building devices. The relationships in the building schema, however, may not be accurate (e.g., out of data, does not reflect faults or design changes, etc.).

The correlation system can compare the relationships generated based on the correlations between one or more control devices and one or more building devices to detect whether any relationships are missing or incorrect in the building schema. For example, the correlation system can iterate through the generated relationships to identify each relationship associated with each building system. If the correlation system determines that all building relationships generated based on the correlations are present in the building schema, the correlation system can determine that the building schema is accurate. Otherwise, the correlation system can determine that the building schema is missing one or more relationships, or that one or more relationships are incorrect in the building schema. The correlation system can record these issues in one or more data structures the memory of the correlation system, or provide indications of the inconsistencies to an external computing system (e.g., a cloud computing system, a user device via a graphical user interface, etc.).

The correlation system can verify (e.g., periodically, according to a schedule, in response to a request from a user device, etc.) whether any of the building systems are experiencing a fault. For example, after establishing a baseline set of relationships that are known to be accurate, the correlation system can determine whether there any relationships have been changed between the building systems, which may indicate a fault in a building device or a control device. For example, the correlation system can perform the techniques described herein on a monthly basis, a bi-monthly basis, a quarterly basis, or a yearly basis to detect any changes to the relationships between building systems. If any changes are detected (e.g., new relationships formed, existing relationships no longer being present, etc.), a flag can be set in the memory of the correlation system that indicates the changed relationships. These changed relationships can be presented to a user via a graphical user interface of a user device, or provided to a cloud computing system 540 for presentation in a web-based interface, for example.

The correlation system can, in some implementations, store the relationships as part of a building schema, or update an existing building schema, for the building that includes the building systems. The building schema can be updated to optimize the on-time and off-time of the control devices and the building devices to achieve desired building conditions (e.g., air temperature, air pressure, water temperature, water pressure, etc.) during predetermined time periods (e.g., while the building is occupied, while the building is not occupied, etc.). The correlation system can generate relationships between building devices for different time periods. For example, certain building equipment (e.g., heating equipment) may affect different sensors differently depending on the season (e.g., winter versus summer). Detection of faults in the building systems can be further based on the climate, location, and time of year for the building.

The correlation system can generate a graphical user interface that provides a visualization of at least a portion of the one or more correlations. The visualizations can be, for example, a visualization of a graph data structure, in which each node in the graph is designated as a respective building device or control device, and the edges in the graph reflect the relationships detected by the correlation system. In some implementations, a corresponding graph of the expected relationships between building devices and control devices can be displayed in a second visualization (e.g., an overlay). The expected relationships may be retrieved, for example, from a building schema of the corresponding building. The visualizations may be provided in response to a request, for example, by a cloud computing system or web server. The graphical user interfaces may be updated upon generating the one or more relationships. In some implementations, the graphical user interface can provide a building information modeling (BIM) interface that indicates the one or more relationships between the building devices and/or the control devices.

Referring now to FIG. 7, a flowchart of an example process 700 for automatically defining control relationships between building systems is shown, according to some embodiments. Process 700 may be implemented by the system 500, for example, and at least in part by the correlation system 502. As described above, the correlation system 502 can automatically identify relationships between building devices (e.g., the building devices 554) and control devices (e.g., the control devices 552) based on time-series data received or retrieved from said building systems. It will be appreciated that certain steps of process 700 may be optional and, in some embodiments, process 700 may be implemented using less than all of the steps, or steps perform in alternative orders.

At step 705, a first control device (e.g., a control device 552) of a building is identified. The first control device can be configured to control at least one physical parameter of a space of the building. The first control device can be, for example, an air handling unit. The control devices can include any type of building system that can control a physical parameter (e.g., air temperature, air pressure, water temperature, water pressure) of a building. For example, the control devices may include air handler units. The control devices can include sensors that provide data relating to the particular control device, such as return air temperature, return air pressure, return water temperature, or return water pressure, among others. The control devices may be referred to as “source devices” or “source systems,” because they can provide a “source” (e.g., air, water) that is “consumed” by “load devices” or “load systems” within the building.

The control device of the building can be identified, for example, by communicating with one or more building servers that maintain a registry, lookup table, or repository that stores identifiers of the control devices of the building. In some implementations, the correlation system (and/or one or more intermediary devices or servers) can perform a discovery process (e.g., by communicating with one or more local building computing systems or gateways) to identify one or more control devices. In some implementations, one or more control devices may be identified by a building schema (e.g., a Brick schema) stored locally at the correlation system. In some implementations, the first control device can be selected or identified as part of an iterative testing process. For example, test signals (e.g., the test signals 514) may identify an activation pattern of one or more control devices of the building, for example, to detect relationships between one or more control devices and one or more building devices (e.g., the building devices 554) of a building. The first control device can be identified based on the test signals.

At step 710, a first building device the building can be identified. The first building device can measure the at least one physical parameter within the building. In some implementations, the building device is a VAV device. The building devices can include any type of device that can monitor the physical parameters of the building that are controlled at least in part by the control devices. For example, the building devices can include sensors (e.g., air temperature, air pressure, water temperature, water pressure, etc.) within VAVs, or other types of devices within a building that may be connected to an AHU or to a waterside system. The building devices can be or may include a variable air volume device. The building devices may also include air or water temperature or pressure sensors disposed in various spaces of the building, for example.

At step 715, it is determined that a relationship between the first control device and the first building device is undefined. For example, the correlation system can access a building schema to identify one or more relationships between building devices or control devices of the building. If the building schema is incomplete, or if there is no relationship between the identified building device and the identified control device, the correlation system can determine that the relationship is undefined. In some implementations, the correlation system can perform one or more tests according to one or more test signals (e.g., the test signals 514), which may indicate that a relationship between one or more building devices and one or more control devices should be identified or verified. In such cases, the relationship between the identified building device and the identified control device can be considered undefined until it can be verified by the correlation system using the techniques described herein. In some implementations, the correlation system may receive a request (e.g., from a user device via a network) to verify or test whether a relationship exists between a building device and a control device, between two building devices, or between two control devices, for example.

At step 720, upon determining that the relationship between the first control device and the first building device is undefined, a relationship between the first control device and the first building device is generated based on one or more correlations determined based on data provided by the control devices and sensor data captured by the building devices. The one or more correlations can be determined by calculating at least one variance inflation factor, cross correlation, and/or Pearson correlation based on the sensor data retrieved from the identified building device and the identified control device. The VIF, cross correlation, and/or Pearson correlation can be calculated using time-series data captured from the devices over the same time period. In some implementations, the sensor data can be captured during a test program or predetermined activation pattern of the control devices in the building. For example, the one or more correlations can be calculated iteratively, for example, between each combination of control devices and building devices, by iteratively activating one or more control devices and deactivating the other control devices of the building, and monitoring sensor data from each of the building devices in the building. In some implementations, one or more building devices can be iteratively activated and de-activated in addition to, or instead of, the control devices of the building.

Using the one or more correlations, the correlation system can generate a confidence score that indicates a strength of a relationship between the identified control device and the identified building device of the building. For example, the VIF, cross correlation, and/or Pearson correlation (or combinations thereof) calculated using the time series data may itself be utilized as a confidence score. In some implementations, the confidence score may be calculated based on the VIF (e.g., by multiplying the VIF, cross correlation, and/or Pearson correlation by a predetermined factor or otherwise transforming the VIF, cross correlation, and/or Pearson correlation etc.). The confidence score may be compared to a predetermined threshold to determine whether the confidence score indicates a relationship. For example, if the confidence score is greater than or equal to 0.5, that may indicate a relationship between the control device and building device for which the confidence score was generated. If a relationship is indicated, a corresponding relationship between the devices can be generated in a building schema, or stored for future configuration or processing techniques. The correlations, and the relationship, can indicate that the identified control device controls at least a portion of the at least one physical parameter of a space of the building (e.g., air temperature, air pressure, water temperature, water pressure, etc.) that is measured by the first building device (e.g., a VAV that is determined to be connected to an AHU that is the control device, etc.). Similarly, if the confidence score is less than a predetermined threshold (e.g., less than 0.2), the confidence score may indicate that the respective building device and control device are unrelated.

The correlation system can repeat the steps of the process 700 to determine any relationships between all source devices (e.g., the control devices) and all load devices (e.g., the building devices) of the building. For example, the correlation system can utilize one or more test programs or test signals (e.g., the test signals 514) to iteratively activate one or more control devices and one or more building devices of the building in order to identify the relationships. In some implementations, if a confidence score (e.g., calculated based on a respective VIF, cross correlation, and/or Pearson correlation as described herein) between a building device and a control device does not satisfy a threshold (e.g., the threshold is less than or equal to a predetermined value), the correlation system can generate an indication that the respective building device and the respective control device are unrelated. In some implementations, if the score does not satisfy the threshold, the sensor data from the devices used to generate the score, along with the correlation score, can be transmitted to an external computing device (e.g., a cloud computing system, a user device, etc.) for verification.

FIG. 8 depicts a graph of time-series data that indicates relationships between an AHU and several VAVs, according to some embodiments. As shown, the graph includes a set of curves 805, each of which correspond to a respective building device (e.g., a building device 554) or a respective control device (e.g., a control device 552). In this example, the curves represent the air temperature as measured by sensors on the respective control device or respective building device. For example, one of the curves 805 corresponds to the suction-air temperature of an AHU (e.g., a control device), and four different VAVs (e.g., building devices) in the building. As shown, the air temperatures of each VAV closely resemble the air temperature of the AHU in the building, indicating a likelihood that the AHU serves each of the VAVs. As such, respective correlation scores between sensor data from each VAV and the AHU would likely be greater than a threshold required to establish a relation between the VAVs and the AHU in a building schema.

FIG. 9 depicts another graph of time-series data that indicates both correct and incorrect relationships between an AHU and several VAVs, according to some embodiments. As shown, the graph includes a first set of curves 905 and a second set of curves 910, each of which correspond to a respective building device (e.g., a building device 554) or a respective control device (e.g., a control device 552). In this example, the curves represent the air temperature as measured by sensors on the respective control device or respective building device. For example, one of the curves 910 corresponds to the suction-air temperature of an AHU (e.g., a control device), and four different VAVs (e.g., building devices) in the building. However, in this example, the first set of curves does not exhibit sensor data that follows the fluctuations in the second set of curves 910. As such, it is likely that a lower correlation score would be calculated for the VAV sensors that provided the sensor data for the first set of curves 905 and the AHU. In contrast, a subset of the VAVs indicated in the second set of curves 910 conform to the sensor data returned by the AHU, indicated that at least some of the VAVs from which sensor data was retrieved are likely served by the AHU.

In some embodiments, various data discussed herein may be stored in, retrieved from, or processed in the context of digital twins. In some such embodiments, the digital twins may be provided within an infrastructure such as those described in U.S. patent application Ser. No. 17/134,661 filed Dec. 28, 2020, Ser. No. 18/080360 filed Dec. 13, 2022, and Ser. No. 17/537,046 filed Nov. 29, 2021, the entireties of each of which are incorporated herein by reference. For example, one or more operations of the correlation system may be performed to modify one or more digital twins to indicate additional relationships or modify existing relationships between building systems (e.g., the building systems 550).

In some embodiments, various data discussed herein may be processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises. In some example implementations, the data may be processed using systems and/or methods such as those described in U.S. patent application Ser. Nos. 17/710,458, 17/710782, 17/710743, 17/710775, 17/710535, and 17/710542 (all filed Mar. 31, 2022), and U.S. Provisional Patent No. 63/411540 filed Sep. 29, 2022, which are all incorporated herein by reference in their entireties. For example, one or more operations of the correlation system may be implemented by various gateway components or software, which may be retrieved from or provided by a cloud system (e.g., the cloud computing system 540). In some implementations, operations described herein as being performed by the computing platform may be performed by one or more edge devices (e.g., the control devices 552, the building devices 554, any other building system 550, etc.).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

What is claimed is:

1. A method of automatically configuring source-load relationships in building systems, comprising:
identifying, by one or more processors coupled to memory, a first control device of a plurality of control devices of a building, the first control device configured to control at least one physical parameter of a space of the building;
identifying, by the one or more processors, a first building device of a plurality of building devices of the building, the first building device configured to measure the at least one physical parameter within the building;
determining, by the one or more processors, that a relationship between the first control device and the first building device is undefined; and
responsive to determining that the relationship between the first control device and the first building device is undefined, generating, by the one or more processors, the relationship between the first control device and the first building device based on one or more correlations determined based on data provided by the plurality of control devices and sensor data captured by the plurality of building devices, the one or more correlations comprising a variance inflation factor or a cross correlation.

2. The method of claim 1, further comprising determining, by the one or more processors, a time shift for the cross correlation based on the data provided by the plurality of control devices and the sensor data.

3. The method of claim 1, further comprising determining the one or more correlations by iteratively activating or de-activating the first control device or the first building device.

4. The method of claim 1, wherein generating the relationship comprises determining, by the one or more processors, that a relationship confidence value calculated based on the one or more correlations satisfies a predetermined threshold.

5. The method of claim 1, wherein the one or more correlations indicate that the first control device controls at least a portion of the at least one physical parameter of the space of the building that is measured by the first building device.

6. The method of claim 1, wherein the first control device is an air handling unit and the first building device is a variable air volume device.

7. The method of claim 1, further comprising:
determining, by the one or more processors, that a second relationship between the first control device of the plurality of control devices and a second building device of the plurality of building devices is undefined; and
responsive to determining that the relationship between the first control device and the second building device is undefined, generating, by the one or more processors, a relationship confidence value that indicates a likelihood that the first control device controls in part a parameter of the building that is measured by the second building device.

8. The method of claim 7, further comprising generating, by the one or more processors, an indication that the second building device and the first control device are unrelated responsive to the relationship confidence value being less than a confidence threshold.

9. The method of claim 7, further comprising generating, by the one or more processors, the second relationship between the second building device and the first control device responsive to the relationship confidence value being satisfying a confidence threshold.

10. A system for automatically configuring source-load relationships in building systems, comprising:
one or more processors coupled to memory, the one or more processors configured to:
identify a first control device of a plurality of control devices of a building, the first control device configured to control at least one physical parameter of a space of the building;
identify a first building device of a plurality of building devices of the building, the first building device configured to measure the at least one physical parameter within the building;
determine that a relationship between the first control device and the first building device is undefined; and
responsive to determining that the relationship between the first control device and the first building device is undefined, generate the relationship between the first control device and the first building device based on one or more correlations determined based on data provided by the plurality of control devices and sensor data captured by the plurality of building devices, the one or more correlations comprising a variance inflation factor or a cross correlation.

11. The system of claim 10, wherein the one or more processors are further configured to determine a time shift for the cross correlation based on the data provided by the plurality of control devices and the sensor data.

12. The system of claim 10, wherein the one or more processors are further configured to determine the one or more correlations by iteratively activating or de-activating the first control device or the first building device.

13. The system of claim 10, wherein the one or more processors are further configured to generate the relationship by performing operations comprising determining that a relationship confidence value calculated based on the one or more correlations satisfies a predetermined threshold.

14. The system of claim 10, wherein the one or more correlations indicate that the first control device controls at least a portion of the at least one physical parameter of the space of the building that is measured by the first building device.

15. The system of claim 10, wherein the first control device is an air handling unit and the first building device is a variable air volume device.

16. The system of claim 10, wherein the one or more processors are further configured to:
determine that a second relationship between the first control device of the plurality of control devices and a second building device of the plurality of building devices is undefined; and
responsive to determining that the relationship between the first control device and the second building device is undefined, generate a relationship confidence value that indicates a likelihood that the first control device controls in part a parameter of the building that is measured by the second building device.

17. The system of claim 16, wherein the one or more processors are further configured to generate an indication that the second building device and the first control device are unrelated responsive to the relationship confidence value being less than a confidence threshold.

18. The system of claim 16, wherein the one or more processors are further configured to generate the second relationship between the second building device and the first control device responsive to the relationship confidence value being satisfying a confidence threshold.

19. A non-transitory computer-readable medium with processor-executable instructions embodied thereon that, when executed by one or more processors, cause the one or more processors to perform operations comprising:
identifying a first control device of a plurality of control devices of a building, the first control device configured to control at least one physical parameter of a space of the building;
identifying a first building device of a plurality of building devices of the building, the first building device configured to measure the at least one physical parameter within the building;
determining that a relationship between the first control device and the first building device is undefined; and
responsive to determining that the relationship between the first control device and the first building device is undefined, generating the relationship between the first control device and the first building device based on one or more correlations determined based on data provided by the plurality of control devices and sensor data captured by the plurality of building devices, the one or more correlations comprising a variance inflation factor or a cross correlation.

20. The non-transitory computer-readable medium of claim 19, wherein the operations further comprise determining a time shift for the cross correlation based on the data provided by the plurality of control devices and the sensor data.
